(19) United States
(12) Patent Application Publication
(10) Pub. No.: US 2025/0148495 A1
(43) Pub. Date: May 8, 2025

(54) BEHAVIOR CHANGE INTERVENTION SYSTEM, BEHAVIOR CHANGE INTERVENTION METHOD, AND NON-TRANSITORY COMPUTER READABLE STORAGE MEDIUM

(71) Applicant: Oki Electric Industry Co., Ltd., Tokyo (JP)

(72) Inventor: Koji SAKURADA, Tokyo (JP)

(73) Assignee: Oki Electric Industry Co., Ltd., Tokyo (JP)

(21) Appl. No.: 18/937,896

(22) Filed: Nov. 5, 2024

(30) Foreign Application Priority Data
Nov. 7, 2023 (JP) 2023-189822

(51) Int. Cl. G06Q 30/0226; G06N 7/01

(52) U.S. Cl. CPC G06Q 30/0226; G06N 7/01

(57) ABSTRACT

It is an object of the present invention to efficiently habituate a behavior of a target. A behavior change intervention system is provided. The behavior change intervention system includes a decision section configured to obtain progress data by deciding a progress of behavior change related to a target behavior of a target, a determination section configured to determine a selection probability of each type for selecting intervention information for the target, based on the progress data and a provision section configured to provide to the target with the intervention information for the target based on the selection probability.

### CROSS REFERENCE TO RELATED APPLICATION(S)

This application is based upon and claims benefit of priority from Japanese Patent Application No. 2023-189822, filed on Nov. 7, 2023, the entire contents of which are incorporated herein by reference.

### BACKGROUND

The present invention relates to a behavior change intervention system, a behavior change intervention method, and a non-transitory computer readable storage medium.

In recent years, there are multiple services for providing financial incentives for execution of behaviors to encourage a specific behavior of a target (e.g., a health behavior or an environmentally friendly behavior). These services need to secure a return on investment (e.g., reduction of a medical fee or reduction of a greenhouse gas) after a service provider secures a fund of the financial incentive.

For example, JP 2022-69818 discloses a configuration example of a system that allocates a financial incentive for intensively motivating specific members set per group such as a company to promote health consciousness and behavior, and encourage the specific members to change behaviors. Consequently, it is possible to intensively give the financial incentive to a target layer of a high health risk, and achieve efficient investment allocation for the group.

### SUMMARY

However, although it is possible to induce a temporary behavior of a target by giving a financial incentive, it is necessary to continuously provide the financial incentive to the target while gradually raising the financial incentive to make the target continue the behavior.

Furthermore, it is known that, when the financial incentive is given to the target, intrinsic motivation of the target (motivation produced by an inner factor of a person) lowers, and the behavior of the target also gradually decreases. Furthermore, when the financial incentive to be given to the target is stopped, the behavior of the target may also stop. In view of the above, there is a problem that it is difficult to habituate a behavior of a target only by giving a financial incentive.

It is therefore an object of the present invention to solve the above problem, and efficiently habituate a behavior of a target.

In order to solve the above problems, according to one aspect of the present invention, a behavior change intervention system is provided. The behavior change intervention system include a decision section configured to obtain progress data by deciding a progress of behavior change related to a target behavior of a target, a determination section configured to determine a selection probability of each type for selecting intervention information for the target based on the progress data and a provision section configured to provide to the target with the intervention information for the target based on the selection probability.

The determination section may acquire an average number of times of selection during a predetermined time associated with each of one or a plurality of types to which an intervention information group belongs, and the progress data, determine based on the average number of times of selection and an output probability of the intervention information for the target the selection probability that is a probability of each type for selecting intervention information belonging to the type as the intervention information for the target.

The intervention information group may include a first type to which intervention information for recommending execution of the target behavior belongs, and the average number of times of selection associated with the first type may be larger as the progress data is higher in a section in which the progress data is smaller than predetermined first progress data, and is smaller as the progress data is higher in a section in which the progress data is higher than the first progress data.

The intervention information group may include a second type to which intervention information indicating an intrinsic reward given to execution of the target behavior belongs, and the average number of times of selection associated with the second type may be larger as the progress data is higher.

The intervention information group may include a third type to which intervention information indicating an extrinsic reward given to execution of the target behavior belongs, and the average number of times of selection associated with the third type may be smaller as the progress data is higher.

The intervention information group may include a fourth type to which intervention information indicating an effect obtained by execution of the target behavior belongs, and the average number of times of selection associated with the fourth type may be smaller as the progress data is higher.

The determination section may acquire an output probability of the intervention information for the target associated with a time zone to which a current time belongs as a current time message output probability, and determine the selection probability based on multiplication of the current time message output probability and the average number of times of selection.

When type candidate data including one or a plurality of types to which an intervention information group belongs includes a predetermined type to which intervention information related to a reward given to execution of the target behavior belongs, the determination section may determine whether or not to use the intervention information included in the intervention information group and belonging to the predetermined type as a candidate of the intervention information for the target as the information related to the provision.

When the type candidate data includes the predetermined type, the determination section may determine whether or not to use the intervention information included in the intervention information group and belonging to the predetermined type as the candidate of the intervention information for the target based on the progress data and a cumulative number of times of a behavior that is a number of times of execution of the target behavior by the target after the intervention information belonging to the predetermined type is lastly provided to the target.

When the type candidate data includes the predetermined type, the determination section may acquire a first value associated with the progress data, and determine whether or not to use the intervention information included in the intervention information group and belonging to the predetermined type as the candidate of the intervention information for the target based on whether or not a number of times after action of a random number on the cumulative number of times of behavior or the cumulative number of times of behavior is the first value or more.

The first value may be larger as the progress data associated with the first value is higher.

When the type candidate data includes the predetermined type, the determination section may determine whether or not to use the intervention information included in the intervention information group and belonging to the predetermined type as the candidate of the intervention information for the target based on the progress data and an elapsed time to a current time from a last time when the intervention information belonging to the predetermined type is provided to the target.

When the type candidate data includes the predetermined type, the determination section may acquire a second value associated with the progress data, and determine whether or not to use the intervention information included in the intervention information group and belonging to the predetermined type as the candidate of the intervention information for the target based on whether or not a time after action of a random number on the elapsed time or the elapsed time is the second value or more.

The second value may be larger as the progress data associated with the second value is higher.

The determination section may acquire an average number of times of selection during a predetermined time associated with each of the one or the plurality of types to which the intervention information group belongs, and the progress data, and determines based on the average number of times of selection a selection probability that is a probability of each type for selecting intervention information belonging to the type as the intervention information for the target, and correct the selection probability associated with the predetermined type to zero when the intervention information included in the intervention information group and belonging to the predetermined type is not used a candidate of the intervention information for the target.

The decision section may specify the intervention information group associated with a situation of the target, and the provision section may determine the intervention information for the target from the intervention information group.

The intervention information for the target may include message data for encouraging the target to execute the target behavior.

The decision section may decide the progress based on at least one of an access frequency of the target to a service function, a number of days of execution of the target behavior by the target, and an acceptance degree of the target for intervention information provided to the target.

In order to solve the above problems, according to another aspect of the present invention, a behavior change intervention method is provided. The behavior change intervention method includes obtaining progress data by deciding a progress of behavior change related to a target behavior of a target, determining a selection probability of each type for selection intervention information to the target based on the progress data, and providing to the target with the intervention information for the target based on the selection probability.

In order to solve the above problems, according to another aspect of the present invention, a non-transitory computer readable storage medium having recorded therein a program is provided. The program may cause a computer to function as a decision section configured to obtain progress data by deciding a progress of behavior change related to a target behavior of a target, a determination section configured to determine a selection probability of each type for selecting intervention information for the target based on the progress data, and a provision section configured to provide to the target with the intervention information for the target based on the selection probability.

As described above, according to the present invention, there is provided a technique that can efficiently habituate a behavior of a target.

### BRIEF DESCRIPTION OF DRAWINGS

FIG. 1 is a diagram illustrating a configuration example of a behavior change intervention system according to an embodiment of the present invention.

FIG. 2 is a view for describing an operation of the behavior change intervention system according to the embodiment of the present invention.

FIG. 3 is a view illustrating an example of terminal response data.

FIG. 4 is a view illustrating an example of behavior analysis data.

FIG. 5 is a view illustrating an example of a message database.

FIG. 6 is a view illustrating an example of message candidate set data.

FIG. 7 is a view illustrating an example of a correspondence between progress data and a cumulative behavior count parameter N.

FIG. 8 is a view illustrating an example of the average number of times of selection per day associated with the progress data and a type to which message data belongs.

FIG. 9 is a diagram illustrating a hardware configuration of an information processing device 900 that is an example of a hardware configuration of a server according to the embodiment of the present invention.

FIG. 10 is a view illustrating an example of a correspondence between progress data and a time lapse parameter T.

### DETAILED DESCRIPTION OF THE EMBODIMENT(S)

A preferred embodiment of the present invention will be described in detail below with reference to the accompanying drawings. Note that components including substantially identical functional configurations will be assigned identical reference numerals in the description and the drawings, and redundant description will be omitted.

### 0. Outline

First, the outline of the embodiment of the present invention will be described.

The embodiment of the present invention mainly proposes a technique of effectively habituating a behavior of a target by intervening the target according to a progress of behavior change of the target. More specifically, according to the embodiment of the present invention, the frequency of intervention to the target is controlled according to the progress of the behavior change of the target. Consequently, it is possible to more effectively habituate the behavior of the target. Furthermore, according to the embodiment of the present invention, a timing to intervene the target is controlled.

For example, the frequency to intervene the target may be controlled by thinning intervention to the target. For example, the frequency to intervene the target may be controlled by selecting a type of intervention based on a selection probability determined per type of intervention to the target.

A timing to intervene the target may be controlled by selecting the type of intervention based on a probability of intervention determined per time zone of intervention to the target. The probability of intervention may correspond to a “message output probability” described later.

Control examples of this frequency or timing of intervention to the target will be described in detail later.

Intervention to the target may be performed by providing, to the target, information (hereinafter, also referred to as “intervention information”) for encouraging the target to execute a target behavior. The intervention information may be provided to the target by a terminal of the target by presenting the intervention information to the target, or by an information processing device by outputting the intervention information to the terminal of the target.

The following description mainly assumes a case where the intervention information includes text data (hereinafter, also referred to as “message data”). However, the intervention information may include data other than the text data. For example, the intervention information may include image data (e.g., still image data or moving image data)

The outline of the embodiment of the present invention has been described above.

### 1. Details of Embodiment

Next, details of the embodiment of the present invention will be described.

### 1-1. Description of Configuration

A configuration example of a behavior change intervention system according to the embodiment of the present invention will be described. A user of the behavior change intervention system (hereinafter, simply referred to as a “user”) according to the embodiment of the present invention is a target who needs to habituate a target behavior. The user executes the target behavior according to a situation. The embodiment of the present invention mainly assumes a case where the target behavior is use of a staircase (hereinafter, also referred to as “staircase walking”). However, as will be described later, the target behavior is not limited to staircase walking.

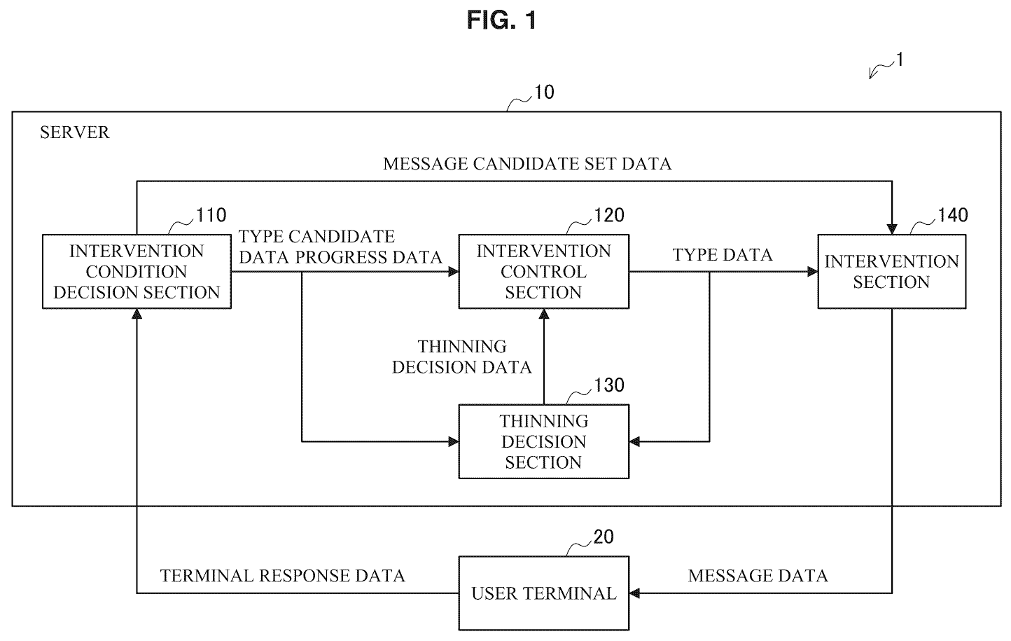

FIG. 1 is a diagram illustrating the configuration example of the behavior change intervention system according to the embodiment of the present invention. As illustrated in FIG. 1, a behavior change intervention system 1 according to the embodiment of the present invention includes a server 10 and a user terminal 20. The server 10 and the user terminal 20 are connected to a network, and the server 10 and the user terminal 20 are configured to be able to communicate with each other via the network.

### Server 10

The server 10 may be implemented as a computer. The server 10 includes an unillustrated control section and an unillustrated storage section. The unillustrated control section includes an intervention condition decision section 110, an intervention control section 120, a thinning decision section 130, and an intervention section 140.

Note that the unillustrated control section is implemented by a processor by executing a program. This program is recorded in a storage medium, and may be read from the storage medium and executed by the processor. Alternatively, the unillustrated control section may be configured as dedicated hardware.

The unillustrated storage section may be configured as a memory. For example, the memory may be a memory such as a Random Access Memory (RAM), a hard disk drive, or a flash memory.

### Intervention Condition Decision Section 110

The intervention condition decision section 110 acquires terminal response data output from the user terminal 20. Note that the terminal response data may also correspond to behavior data. Furthermore, the intervention condition decision section 110 outputs type candidate data and progress data to the intervention control section 120 based on the terminal response data. Details of the type candidate data and the progress data will be described later. Furthermore, the intervention condition decision section 110 outputs the type candidate data and the progress data to the thinning decision section 130.

The intervention condition decision section 110 outputs message candidate set data to the intervention section 140 based on the terminal response data. Details of the message candidate set data will be described later.

### Intervention Control Section 120

The intervention control section 120 outputs the type candidate data and the progress data output from the intervention condition decision section 110. Furthermore, the intervention control section 120 acquires thinning decision data output from the thinning decision section 130. Details of the thinning decision data will be described later. The intervention control section 120 outputs type data to the thinning decision section 130. Details of the type data will be described later. Furthermore, the intervention control section 120 outputs the type data to the intervention section 140 based on the type candidate data, the progress data, and the thinning decision data.

### Thinning Decision Section 130

The thinning decision section 130 acquires the type candidate data and the progress data output from the intervention condition decision section 110. Furthermore, the thinning decision section 130 outputs the type data output from the intervention control section 120. The thinning decision section 130 outputs the thinning decision data to the intervention control section 120 based on the type candidate data, the progress data, and the type data.

### Intervention Section 140

The intervention section 140 acquires the type data output from the intervention control section 120. Furthermore, the intervention section 140 determines message data based on the type data. Furthermore, the intervention section 140 outputs the message data to the user terminal 20.

### User Terminal 20

The user terminal 20 may be implemented as a computer. For example, the user terminal 20 may be a terminal (portable terminal) that is carried by the user and is operated by the user.

When receiving the message data output from the intervention section 140, the user terminal 20 presents the received message data to the user. For example, the user terminal 20 may cause a display to display the message data on a screen or cause a speaker to output the message data as an audio. Furthermore, the user terminal 20 outputs the terminal response data to the intervention condition decision section 110 in response to a request from the intervention condition decision section 110.

### Service Function

The user terminal 20 has service functions for the user. For example, the service function may include at least one of an autonomy function, a competence function, a relationship function, a message browsing function, a message acceptance degree acquisition function, and a behavior registration function. The service function may be a service function related to staircase walking.

### Autonomy Function

The autonomy function may be a function of detecting a behavior selected by the user, and presenting, to the user, details of the behavior selected by the user. For example, the autonomy function may be a function of detecting a staircase use situation per day of the user (e.g., the user went up and down a three-story staircase yesterday or went up and down a two-story staircase the day before yesterday), and presenting the detected staircase use situation to the user.

### Competence Function

The competence function may be a function of presenting to the user a superior result related to staircase use of the user. For example, the superior result may be information indicating to what degree the staircase use situation of the user is superior to staircase use situations of other users (e.g., information indicating that a yesterday's staircase up/down quantity of the user is one story larger than a yesterday's staircase up/down quantity of another user).

Alternatively, the superior result may be information indicating to what degree a today's staircase use situation of the user is superior to a yesterday's staircase use situation of the user (e.g., information indicating that a today's staircase up/down quantity of the user is one story larger than a yesterday's staircase up/down quantity of the user). Alternatively, the superior result may be ranking information obtained by ranking the staircase up/down quantities of a plurality of users including the user and the other users in order from a higher staircase up/down quantity.

### Relationship Function

The relationship function may be a function of sharing the staircase use situation of the user between the user and the other users. For example, the relationship function may be a function of enabling not only the user but also the other users to browse the staircase use situation of the user. For example, the user terminal 20 used by the user and terminals used by other users may share the staircase use situation directly via the network. The user terminal 20 used by the user and the terminals used by the other users may share the staircase use situation via the server 10.

### Message Browsing Function

The message browsing function may be a function of presenting to the user the message data output from the intervention section 140.

### Message Acceptance Degree Acquisition Function

The message acceptance degree acquisition function may be a function of acquiring the acceptance degree (hereinafter, also referred to as a “message acceptance degree”) of the user for the message data presented to the user. The message acceptance degree indicates a user's response at a time when the user browses the message data. Hereinafter, a case will be mainly assumed where the message acceptance degree has two options and is indicated by “1: acceptable” and “0: unacceptable”. However, message acceptance degree candidates may be three types or more. For example, the message acceptance degree may be acquired based on a user's operation.

### Behavior Registration Function

The behavior registration function may be a function of registering execution of a behavior based on the user's operation. For example, the behavior whose execution is registered by the behavior registration function may be mainly a behavior (e.g., eating) that is difficult to detect using a sensor. For example, whether or not the behavior is executed may be input to a registration page from the user. Alternatively, when, for example, contents for inquiring selection of whether or not the behavior is executed includes the message data, whether or not the behavior selected by the user is executed may be included in a reply to the message data.

The configuration example of the behavior change intervention system 1 according to the embodiment of the present invention has been described above.

### 1-2. Description of Operation

Next, an operation example of the behavior change intervention system 1 according to the embodiment of the present invention will be described.

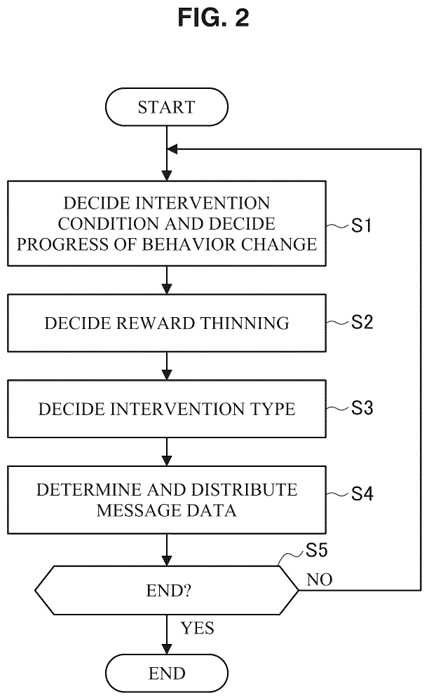

FIG. 2 is a view for describing an operation of the behavior change intervention system 1 according to the embodiment of the present invention. As illustrated in FIG. 2, the operation of the behavior change intervention system 1 according to the embodiment of the present invention is classified into steps of (S1) decision on an intervention condition and decision on a progress of behavior change, (S2) decision on reward thinning, (S3) decision on an intervention type, (S4) determination and distribution of message data, and (S5) decision on whether or not to finish an operation.

Hereinafter, each of these steps will be described in order.

### (S1) Decision on Intervention Condition and Decision on Progress of Behavior Change

The intervention condition decision section 110 decides whether or not a decision timing has arrived. For example, the decision timing comes at a predetermined cycle (hereinafter, also referred to as a “decision cycle”). Hereinafter, a case will be mainly assumed where the decision cycle is 10 minutes. However, the decision cycle may be arbitrarily set according to a target behavior type, a use mode of the behavior change intervention system 1, or the like. For example, the decision cycle may be one minute.

When the decision timing comes, terminal response data to a current time from 10 minutes before with the current time serving as a reference is handled as current terminal response data.

The intervention condition decision section 110 acquires the current terminal response data from the user terminal 20 when the decision timing arrives. Furthermore, the intervention condition decision section 110 analyzes the acquired current terminal response data and acquired terminal response data, and obtains behavior analysis data.

Here, a case will be mainly assumed where terminal response data to a current time from two weeks before with the current time serving as the reference to obtain behavior analysis data. That is, the terminal response data to the current time from two weeks before with the current time serving as the reference is handled as terminal response data of a current period. However, a period of analysis target terminal response data is not limited to two weeks. For example, the period of the analysis target terminal response data may be one week or the like.

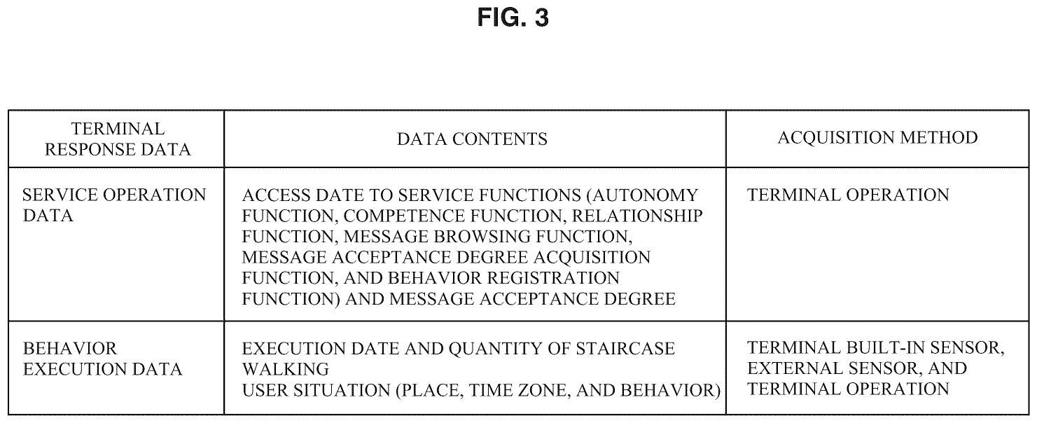

FIG. 3 is a view illustrating an example of the terminal response data. As illustrated in FIG. 3, the terminal response data includes service operation data and behavior execution data.

### Service Operation Data

The service operation data is operation data of the user related to the service function provided to the user by the user terminal 20. As illustrated in FIG. 3, the service operation data includes an access date from the user to the service function (the autonomy function, the competence function, the relationship function, the message browsing function, the message acceptance degree acquisition function, and the behavior registration function), a message acceptance degree that is the acceptance degree of the user for the message data, and the like. The service operation data is acquired by operating the user terminal 20.

### Behavior Execution Data

The behavior execution data is data indicating when the user has executed staircase walking and data indicating how much the user has executed the staircase walking. That is, as illustrated in FIG. 3, the behavior execution data may include an execution date and quantity of staircase walking. The behavior execution data may be acquired based on a user's input operation on a sensor built in the user terminal 20, a sensor provided outside the user terminal 20, or the user terminal 20.

For example, execution of staircase walking may be detected by the user terminal 20 based on a detection result of an atmospheric pressure obtained by an atmospheric pressure sensor built in the user terminal 20 or a detection result of an acceleration obtained by an acceleration sensor built in the user terminal 20.

Alternatively, execution of staircase walking may be detected by the user terminal 20 based on a fact that a receiver built in the user terminal 20 has received a radio wave from a beacon installed at a staircase or near the staircase. Alternatively, execution of staircase walking may be detected by the user terminal 20 based on a fact that a position detected by a Global Navigation Satellite System (GNSS) sensor built in the user terminal 20 belongs to a staircase area set in advance.

Furthermore, the behavior execution data includes a user's situation. The user's situation may include a place at which the user currently exists, a time zone to which the current time belongs, a user's current behavior, and the like. Note that the user's situation may not include all of or may include one or two of a place at which the user currently exists, a time zone to which the current time belongs, and a user's current behavior.

For example, the place at which the user currently exists may be information indicating an area to which the position detected by the GNSS sensor belongs. Furthermore, the time zone to which the current time belongs may be information acquired by a calculation function of measuring the current time. Furthermore, similarly to execution of staircase walking, the user's current behavior may be detected based on a detection result of an atmospheric pressure obtained by the atmospheric pressure sensor or a detection result of an acceleration obtained by the acceleration sensor.

### Behavior Analysis Data

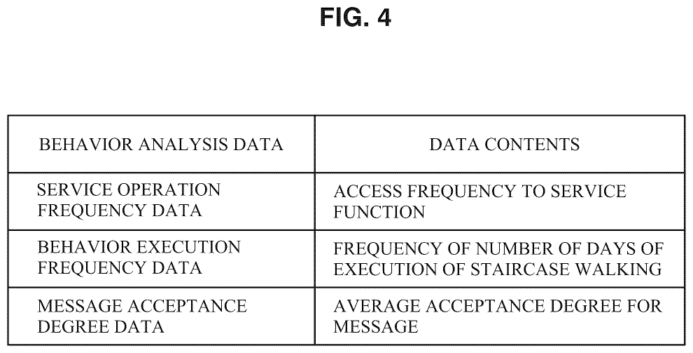

FIG. 4 is a view illustrating an example of behavior analysis data. As illustrated in FIG. 4, the behavior analysis data includes service operation frequency data, behavior execution frequency data, and message acceptance degree data.

### Service Operation Frequency Data

The service operation frequency data is data indicating an access frequency of the user to each service function calculated by the intervention condition decision section 110 based on the service operation data of the terminal response data. For example, the access frequency of the user to the autonomy function is a result obtained by counting the number of times of user's access to the autonomy function during a current period based on an access date of the user to the autonomy function.

### Behavior Execution Frequency Data

The behavior execution frequency data is data indicating a frequency of the number of days of execution of staircase walking calculated by the intervention condition decision section 110 based on the behavior execution data of the terminal response data. For example, the frequency of the number of days of execution of staircase walking is a result obtained by counting the number of days at which the user has executed staircase walking of a predetermined quantity or more during the current period.

### Message Acceptance Degree Data

The message acceptance degree data is data indicating a tendency of the message acceptance degree calculated by the intervention condition decision section 110 based on the message acceptance degree of the service operation data of the terminal response data. For example, the tendency of the message acceptance degree may be an average value of the message acceptance degrees (i.e., an average acceptance degree for a message) of the user during the current period. For example, the average value is indicated by a value equal to or more than zero and equal to or less than one.

### Message Database

The intervention condition decision section 110 holds in advance as a message database a database including a message data group including one or a plurality of items of “message data”, and “type”, “place”, “time zone”, and “immediate behavior” associated with each of the one or the plurality of items of “message data”. Note that the message data group may correspond to an example of an intervention information group.

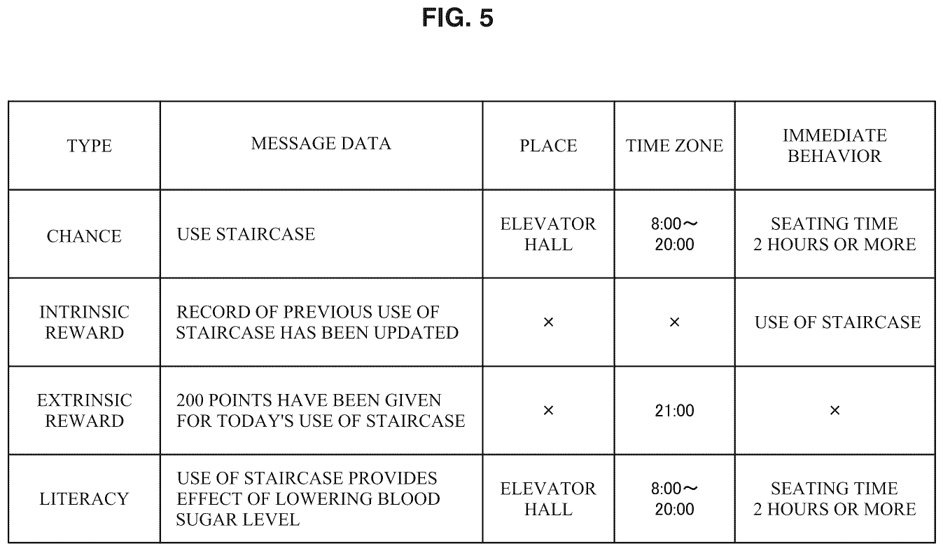

FIG. 5 is a view illustrating an example of the message database. As illustrated in FIG. 5, one or a plurality of items of data associated with “type”, “message data”, “place”, “time zone”, and “immediate behavior” are registered in the message database. Note that, in the example illustrated in FIG. 5, the number of items of “message data” associated with one “type” is one. However, a plurality of items of “message data” may be associated with one “type”.

“Type” indicates a type of message data. A case will be mainly described in the following description that four types of a type “chance”, a type “intrinsic reward”, a type “extrinsic reward”, and a type “literacy” are used as examples of “type”. However, “type” is not limited to these examples. Note that “intrinsic reward” and “extrinsic reward” will be also referred to as “reward” without being distinguished in particular in the following description.

The type “chance” is a type (first type) to which message data for recommending the user to execute staircase walking belongs. Providing the message data belonging to the type “chance” to the user may become a chance for the user to start staircase walking.

The type “intrinsic reward” is a type (second type) to which message data indicating the intrinsic reward of rewards to be given for execution of staircase walking belongs. For example, the type “intrinsic reward” may be a type to which message data for responding to an inner desire of the user (such as autonomy, competence, and a relationship) in the message data to be provided to the user immediately after the user executes staircase walking belongs.

The type “extrinsic reward” is a type (third type) to which message data indicating the extrinsic reward of the rewards to be given for execution of staircase walking belongs. For example, the type “extrinsic reward” may be a type to which message data for responding to an outer desire given from other than the user such as a financial incentive or goods in the message data to be provided to the user immediately after the user executes staircase walking belongs.

The type “literacy” is a type (fourth type) to which message data indicating an effect obtained by execution of staircase walking belongs. The effect obtained by execution of staircase walking may be a physical effect. For example, the type “literacy” may be a type to which message data corresponding to knowledge for enhancing capability of the user to obtain, understand, evaluate and utilize information related to staircase walking belongs.

Each of “place”, “time zone”, and “immediate behavior” may correspond to an example of a user's situation. “Place” and “time zone” may correspond to conditions related to a user's environment. “Place” in particular may correspond to the condition related to a place at which the user exists. Furthermore, “time zone” may correspond to the condition related to a time zone at a place at which the user exists. “Immediate behavior” may correspond to a condition related to a user's behavior from a predetermined time before the current time (e.g., two hours before the current time) to the current time (i.e., immediately before the current time).

In other words, “place”, “time zone”, and “immediate behavior” may be conditions indicating what the user has been doing at what time and at what place. Note that “x” indicates that there is no condition in the example illustrated in FIG. 5.

### Decision on Intervention Condition

The intervention condition decision section 110 specifies a message data group matching the user's situation based on the user's situation included in current terminal response data output from the user terminal 20. In this case, the message data group may be specified taking into account not only the current terminal response data, but also immediate terminal response data.

More specifically, the intervention condition decision section 110 specifies, from the message database, “message data” associated with “place”, “time zone”, and “immediate behavior” matching with the user's situation, that is, the place at which the user exists, the time zone, and the user's behavior.

The intervention condition decision section 110 generates message candidate set data based on specified “message data”. Furthermore, the intervention condition decision section 110 outputs the generated message candidate set data to the intervention section 140.

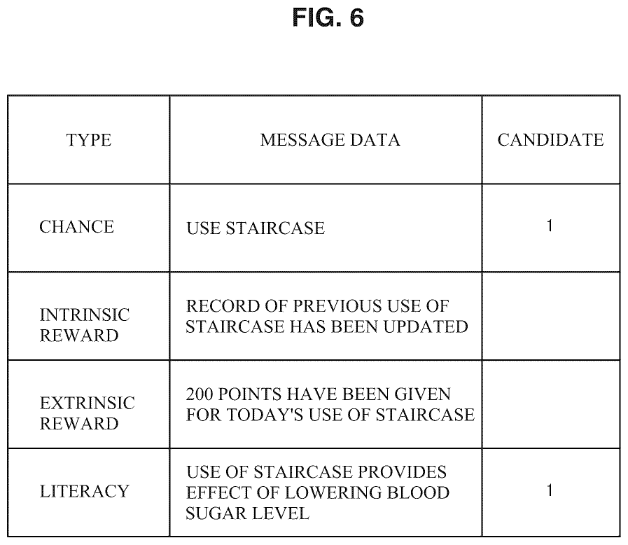

FIG. 6 is a view illustrating an example of message candidate set data. As illustrated in FIG. 6, the message candidate set data may be configured by associating “type”, “message data”, and “candidate”. Values indicating provision candidates for the user are set to “candidate” associated with the message data specified by the intervention condition decision section 110. In the example illustrated in FIG. 6, a value indicating the provision candidate for the user is “1”. However, the value indicating the provision candidate for the user is not limited to “1”,

For example, a case is assumed where, at a point of time when the current time is 10 o'clock, the user is at an elevator hall, and a seating time of the user is two hours or more immediately before the current time. In such a case, “message data” indicating that “place” is the elevator hall, 10 o'clock belongs to “time zone”, and “immediate behavior” indicates that “the seating time is two hours or more” is specified from the message database (FIG. 5).

In the example illustrated in FIG. 5, message data “use staircase” and message data “use of staircase provides effect of lowering blood sugar level” are specified. Furthermore, “1 (provision candidate)” is set to “candidate” associated with “message data” specified as described above in the message candidate set data (FIG. 6).

Furthermore, the intervention condition decision section 110 acquires “type” associated with the message data in which “1 (provision candidate)” has been set to “candidate” in the message candidate set data, and generates type candidate data including acquired “type”. The type candidate data may include one type, may include a plurality of types, or may not include even one type.

In the example illustrated in FIG. 6, “1 (provision candidate)” is set to “candidate” associated with each of the message data “use staircase” and the message data “use of staircase provides effect of lowering blood sugar level”. Hence, the intervention condition decision section 110 generates the type candidate data including the type “chance” and the type “literacy” associated with these items of message data.

Furthermore, the intervention condition decision section 110 outputs the generated type candidate data to the intervention control section 120 and the thinning decision section 130.

### Decision on Progress of Behavior Change

The intervention condition decision section 110 functions as an example of a decision section, and obtains progress data by deciding a progress of behavior change related to staircase walking of the user based on terminal response data during the current period. For example, the intervention condition decision section 110 may decide the progress based on service operation frequency data, behavior execution frequency data, and message acceptance degree data based on the terminal response data during the current period. For example, although the progress data may be expressed as a numerical value of 10 levels from 1 to 10, levels of numerical values for expressing the progress data may be other than 10 levels.

For example, the intervention condition decision section 110 may calculate the progress data by performing weighted addition on each of the service operation frequency data, the behavior execution frequency data, and the message acceptance degree data. For example, as a time at which data has been obtained is close to the current time, a weight associated with this data may be larger. However, a method for calculating the progress data may not be limited thereto. In one example, one or two of the service operation frequency data, the behavior execution frequency data, and the message acceptance degree data may be used to calculate the progress data. Next, the operation moves to S2.

### (S2) Decision on Reward Thinning

The thinning decision section 130 acquires the type candidate data and the progress data output from the intervention condition decision section 110. Furthermore, the thinning decision section 130 acquires, as type data, data indicating a type to which the message data output from the intervention section 140 to the user terminal 20 belongs. The thinning decision section 130 functions as an example of a determination section, and determines information related to provision of the message data to the user based on the progress data.

When, for example, the type candidate data includes the type “intrinsic reward”, the thinning decision section 130 determines whether or not to use as a message data candidate for the user the message data belonging to the type “intrinsic reward” that is the information related to provision. Note that, in the following description, not using the message data belonging to the type included in the type candidate data as the message data candidate for the user will be also referred to as “to thin” the message data or “thinning” of the message data.

Although thinning of the message data belonging to the type “intrinsic reward” will be mainly described below, message data belonging to the type “extrinsic reward” may be also thinned likewise. Furthermore, when, for example, the type “intrinsic reward” and the type “extrinsic reward” are not distinguished in particular, message data belonging to the type “reward” may be also thinned likewise. The type “reward” may correspond to an example of a predetermined type.

More specifically, when the type candidate data includes the type “intrinsic reward”, the thinning decision section 130 determines whether or not to thin the message data belonging to the type “intrinsic reward” based on the progress data and the type data.

Here, when the type data acquired from the intervention section 140 includes the type “intrinsic reward”, the thinning decision section 130 holds a time at which the type data has been acquired as a final reward time at which the message data belonging to the type “intrinsic reward” has been provided to the user terminal 20. Furthermore, the thinning decision section 130 counts as a cumulative number of times of behavior the number of times of execution of staircase walking by the user after the final reward time based on the behavior execution data.

Furthermore, when the type candidate data includes the type “intrinsic reward”, the thinning decision section 130 determines whether or not to thin the message data belonging to the type “intrinsic reward” based on the progress data and the cumulative number of times of behavior. At this time, the message data belonging to the type “intrinsic reward” is desirably thinned based on concepts (a1) and (a2) indicated below.

This concepts include that (a1) a frequency of a reward to be given for execution of staircase walking by the user is increased as progress data of behavior change of staircase walking is lower to make the behavior change readily proceed, and (a2) a frequency of a reward to be given for execution of staircase walking by the user is decreased as the progress data of the behavior change of staircase walking is higher to make the behavior change readily proceed.

Furthermore, when the type candidate data includes the type “intrinsic reward”, the thinning decision section 130 acquires a first value (hereinafter, also referred to as a “cumulative behavior count parameter N”) associated with the progress data. Furthermore, the thinning decision section 130 makes a random number act on the cumulative number of times of behavior counted as described above.

Here, a case will be mainly assumed where action of the random number on the cumulative number of times of behavior is addition of the random number to the cumulative number of times of behavior. In this case, the random number may be, for example, a random integer number belonging to a range from −n to +n (in this regard, n represents a positive number). However, the action of the random number on the cumulative number of times of behavior may be multiplication of the random number on the cumulative number of times of behavior, or may be other arithmetic operations of the random number.

The thinning decision section 130 determines whether or not to thin the message data belonging to the type “intrinsic reward” based on whether or not the number of times after the action of the random number is a value of the cumulative behavior count parameter N or more. In this case, as described with reference to the above concepts (a1) and (a2), the cumulative behavior count parameter N is desirably larger as the progress data associated with the cumulative behavior count parameter N is higher.

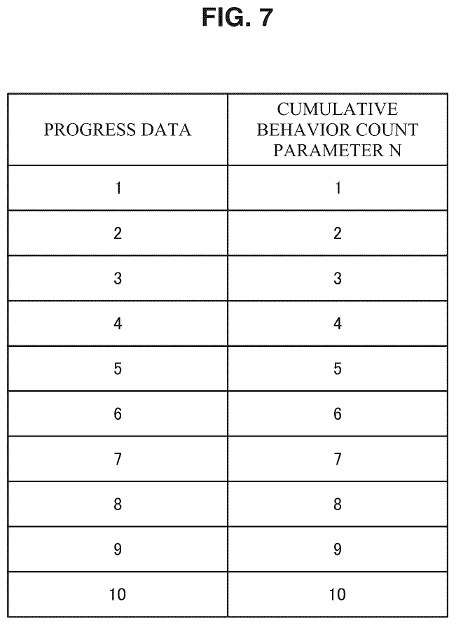

FIG. 7 is a view illustrating an example of a correspondence between progress data and the cumulative behavior count parameter N. As illustrated in FIG. 7, the correspondence between the progress data and the cumulative behavior count parameter N is held in advance by the thinning decision section 130. It is also grasped in the example illustrated in FIG. 7 that the cumulative behavior count parameter N is larger as the progress data associated with the cumulative behavior count parameter N is higher.

The thinning decision section 130 outputs a value indicating whether or not to thin the message data belonging to the type “intrinsic reward” as thinning decision data to the intervention control section 120.

For example, when the type candidate data includes the type “intrinsic reward”, and the message data belonging to the type “intrinsic reward” is thinned, the thinning decision section 130 may output to the intervention control section 120 a value “1: (to thin)” indicating to thin the message data belonging to the type “intrinsic reward” as the thinning decision data. Note that the value indicating to thin the message data belonging to the type “intrinsic reward” may not be “1”.

For example, when the type candidate data includes the type “intrinsic reward”, and the message data belonging to the type “intrinsic reward” is thinned, the thinning decision section 130 may output to the intervention control section 120 a value “0: (not to thin)” indicating not to thin the message data belonging to the type “intrinsic reward” as the thinning decision data. Note that a value indicating not to thin the message data belonging to the type “intrinsic reward” may not be “0”.

On the other hand, when the type candidate data does not include the type “intrinsic reward”, the thinning decision section 130 may output to the intervention control section 120 a value “2: (no type)” indicating that the type candidate data does not include the type “intrinsic reward”. Note that the value indicating that the type candidate data does not include the type “intrinsic reward” may not be “2”. Next, the operation moves to S3.

### (S3) Decision on Intervention Type

The intervention control section 120 outputs the type candidate data and the progress data output from the intervention condition decision section 110. Furthermore, the intervention control section 120 acquires the thinning decision data output from the thinning decision section 130. The intervention control section 120 determines a probability (hereinafter, also referred to as a “selection probability”) of each type for selecting the message data belonging to the type included in the type candidate data as message data for the user based on the type candidate data and the progress data, and corrects the selection probability based on the thinning decision data.

A case will be mainly described in the following description where, when determining the selection probability of each type, the intervention control section 120 takes into account all of the average number of times of selection per day, a message output probability, and the thinning decision data described later. However, when determining the selection probability of each type, the intervention control section 120 may take into account one or two of the average number of times of selection per day, the message output probability, and the thinning decision data.

### Use of Average Number of Times of Selection Per Day

The intervention control section 120 acquires the average number of times of selection per day (hereinafter, also referred to as an “average number of times of selection per day”) associated with the type included in the type candidate data and the progress data. Furthermore, the intervention control section 120 determines a probability (hereinafter, also referred to as a “selection probability”) of each type for selecting the message data belonging to the type included in the type candidate data as the message data for the user based on the acquired average number of times of selection per day.

Note that a calculation period (predetermined period) of the average number of times of selection may not be limited to one day. Furthermore, it may be assumed that an appropriate average number of times of selection matching the progress data differs according to the type to which the message data belongs. For example, the average number of times of selection per day set according to the progress data and the type to which the message data belongs is desirably based on concepts (b1) to (b4) indicated below.

These concepts include that (b1) a chance of a behavior is that, when the chance is provided after consciousness changes to some degree, and the behavior is gradually weakened after the behavior is fixed, the behavior change readily proceeds, (b2) when the intrinsic reward is provided immediately after execution of the behavior irrespectively of a progress of behavior change, habituation readily proceeds, (b3) although the extrinsic reward may induce a behavior when the progress of behavior change is small, if the behavior is not gradually weakened when fixing of the behavior proceeds, the extrinsic reward becomes an end, and the behavior is hardly habituated, and (b4) the literacy is effective to cause change of consciousness at a stage at which the progress of behavior change is low.

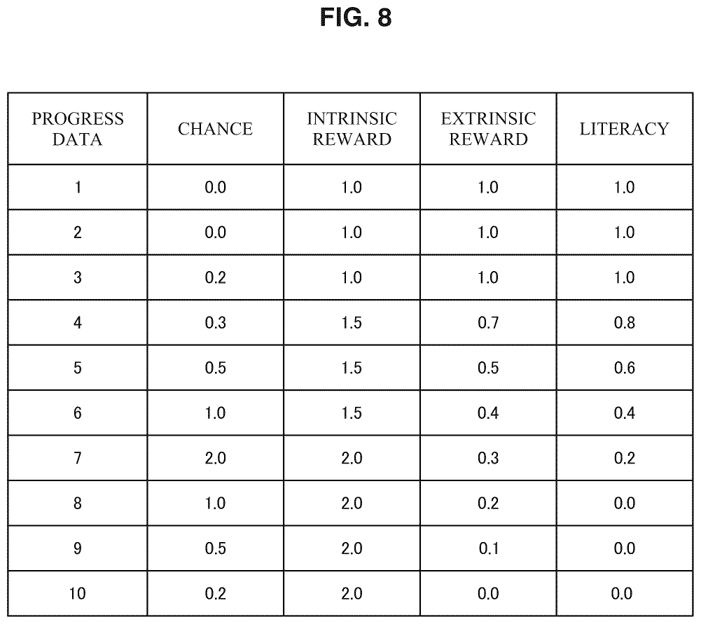

A setting example of the average number of times of selection per day associated with the progress data and the type to which the message data belongs will be described with reference to FIG. 8. FIG. 8 is a view illustrating an example of the average number of times of selection per day associated with the progress data and the type to which the message data belongs. As illustrated in FIG. 8, the correspondence between the progress data, the type to which the message data belongs, and the average number of times of selection per day is held in advance by the intervention control section 120.

Referring to FIG. 8, the average number of times of selection per day associated with the type “chance” is set larger as the progress data is higher in a section in which the progress data is lower than “7”. Furthermore, the average number of times of selection per day associated with the type “chance” is set smaller as the progress data is higher in a section in which the progress data is higher than “7”. Note that the progress data “7” is predetermined progress data (first progress data).

Furthermore, referring to FIG. 8, the average number of times of selection per day associated with the type “intrinsic reward” is set larger as the progress data is higher. On the other hand, the average number of times of selection per day associated with the type “extrinsic reward” is set smaller as the progress data is higher. Furthermore, referring to FIG. 8, the average number of times of selection per day associated with the type “literacy” is set smaller as the progress data is higher.

### Use of Message Output Probability

The message output probability is an output probability of message data for the user per time zone, and is determined according to a lifestyle pattern of the user or a type of a target behavior and is held in advance by the intervention control section 120. The duration of each time zone may be 10 minutes or the like. However, the duration of each time zone may not be limited to 10 minutes. For example, a total value of message output probabilities of 24 hours may be set in advance to “1.0”.

In one example, a case is assumed where the user is a worker working at an office building at 9:00 to 17:00 on weekday, and the target behavior is staircase walking in the office building. In such a case, the message output probability at 9:00 to 17:00 on weekday is desirably set higher than message output probabilities in other time zones.

The intervention control section 120 may acquire a message output probability associated with a time zone to which the current time belongs as a current time message output probability, and determine a selection probability of each type based on the acquired current time message output probability and the average number of times of selection per day. For example, the intervention control section 120 may determine the selection probability of each type based on multiplication of the acquired current time message output probability and the average number of times of selection per day.

A case will be assumed in the example illustrated in FIG. 8 where the progress data is “8” and the current time message output probability is “0.1”. In such a case, the intervention control section 120 can calculate the selection probability associated with the type “chance” as 1.0 (average number of times of selection per day)×0.1 (the current time message output probability)=0.1 (selection probability).

Furthermore, the intervention control section 120 can calculate the selection probability associated with the type “intrinsic reward” as 2.0 (average number of times of selection per day)×0.1 (the current time message output probability)=0.2 (selection probability). Furthermore, the intervention control section 120 can calculate the selection probability associated with the type “extrinsic reward” as 0.2 (average number of times of selection per day)×0.1 (the current time message output probability)=0.02 (selection probability). Furthermore, the intervention control section 120 can calculate the selection probability associated with the type “literacy” as 0 (average number of times of selection per day)×0.1 (the current time message output probability)=0 (selection probability).

### Use of Thinning Decision Data 0

The intervention control section 120 corrects the selection probability based on the thinning decision data. For example, when there is a type for which a value “1: (to thin)” indicating to thin message data is output as the thinning decision data, the intervention control section 120 may correct the selection probability associated with this type to zero.

On the other hand, when there is a type for which a value “0: (not to thin)” indicating not to thin message data is output as the thinning decision data, the intervention control section 120 may not correct the selection probability associated with this type. For example, when there is a type for which a value “2: (no type)” indicating that type candidate data does not include the type is output as the thinning decision data, the intervention control section 120 may not correct the selection probability associated with this type.

### Selection of Type

The intervention control section 120 functions as an example of a determination section, and determines per type whether or not to use the message data that is the information related to provision as a candidate of the message data for the user based on the selection probability of each type. At this time, the intervention control section 120 selects one type at maximum based on the selection probability of each type from one or a plurality of types included in the type candidate data. Furthermore, the intervention control section 120 outputs type data including the selected type to the intervention section 140.

Note that, when any type is not selected, the intervention control section 120 may output type data (i.e., empty type data) that does not include the type to the intervention section 140. Next, the operation moves to S4.

### (S4) Determination and Distribution of Message Data

The intervention section 140 functions as an example of a provision section, and acquires the type data output from the intervention control section 120 and acquires message candidate set data output from the intervention condition decision section 110. Furthermore, the intervention section 140 determines the message data for the user based on the type data and the message candidate set data.

More specifically, the intervention section 140 extracts message data that belongs to the type indicated by the type data and whose “candidate” is “1 (provision candidate)” from the message candidate set data (FIG. 6).

Furthermore, when the extracted message data is a plurality of items of message data, the intervention section 140 may determine one message data at random from the plurality of items of extracted message data as the message data for the user. Alternatively, when the extracted message data is one message data, the intervention section 140 may determine the extracted message data as the message data for the user.

In one example, a case will be assumed where the type data acquired by the intervention section 140 indicates the type “chance”. In such a case, the intervention section 140 extracts the message data “use staircase” that belongs to the type “chance” and whose “candidate” is “1 (provision candidate)” from the message candidate set data (FIG. 6), and determines the extracted message data as the message data for the user.

The intervention section 140 outputs the determined message data to the user terminal 20. Note that a case may be also assumed where the type data acquired by the intervention section 140 does not include the type (i.e., a case where the type data is empty type data). In such a case, the intervention section 140 may not output the message data to the user terminal 20. Next, the operation moves to S5.

### (S5) Decision on Whether or Not to Finish Operation

When the user inputs an operation of finishing use to the user terminal 20, the operation of the behavior change intervention system 1 is finished. When this is not the case, the operation moves to S1.

The operation example of the behavior change intervention system 1 according to the embodiment of the present invention has been described above.

### 1-3. Description of Effect

As described above, in the behavior change intervention system 1 according to the embodiment of the present invention, the intervention condition decision section 110 acquires terminal response data indicating a behavior of the user from the user terminal 20, and outputs type candidate data, progress data, and message candidate set data. Furthermore, the thinning decision section 130 determines whether or not to thin intervention of message data belonging to the type “reward” based on the type candidate data, the progress data, and type data at a time of past intervention, and outputs thinning decision section.

Furthermore, the intervention control section 120 outputs one type data based on the type candidate data, the progress data, and the thinning decision data. Furthermore, the intervention section 140 selects one message data based on the type data and the message candidate set data, and outputs the one message data to the user terminal 20. Consequently, the user can browse the message data on the user terminal 20, and execute a behavior.

The type data output from the intervention control section 120 is a type of message data that is decided by the intervention control section 120 based on the type candidate data and the progress data output by the intervention condition decision section 110, and that is suitable to a progress of behavior change of the user. Furthermore, the message data belonging to the type “reward” can be effectively thinned by the thinning decision section 130 based on the progress of the behavior change of the user.

As described above, the behavior change intervention system 1 according to the embodiment of the present invention can effectively control a frequency or a timing of each type of the message data to be provided to the user according to the progress of the behavior change of the user.

In view of the above, the behavior change intervention system 1 according to the embodiment of the present invention solves the problem that it is difficult for a financial incentive alone to habituate a behavior, effectively intervene the user according to the progress of the behavior change of the user, and lead the user to habituate a specific behavior.

The details of the embodiment of the present invention has been described above.

### 2. Hardware Configuration Example

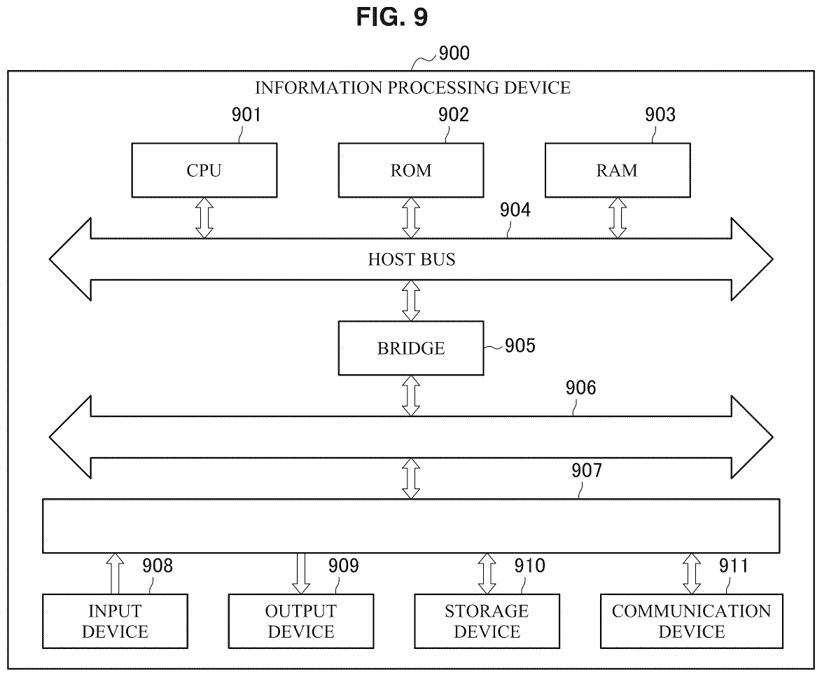

Next, a hardware configuration of an information processing device 900 that is an example of a hardware configuration of the server 10 according to the embodiment of the present invention will be described. FIG. 9 is a diagram illustrating the hardware configuration of the information processing device 900 that is the example of the hardware configuration of the server 10 according to the embodiment of the present invention. Note that a hardware configuration of the user terminal 20 may also be implemented similarly to the hardware configuration of the information processing device 900 illustrated in FIG. 9.

As illustrated in FIG. 9, the information processing device 900 includes a Central Processing section (CPU) 901, a Read Only Memory (ROM) 902, a Random Access Memory (RAM) 903, a host bus 904, a bridge 905, an external bus 906, an interface 907, an input device 908, an output device 909, a storage device 910, and a communication device 911.

The CPU 901 functions as an arithmetic operation processing device and a control device, and controls overall operations in the information processing device 900 according to various programs. Furthermore, the CPU 901 may be a microprocessor. The ROM 902 stores programs, arithmetic operation parameters, and the like used by the CPU 901. The RAM 903 temporarily stores the programs used and executed by the CPU 901, parameters that change as appropriate at a time of execution of the programs, and the like. These CPU 901, ROM 902, and RAM 903 are connected with each other via the host bus 904 configured as a CPU bus or the like.

The host bus 904 is connected to the external bus 906 such as a Peripheral Component Interconnect/Interface (PCI) via the bridge 905. Note that the host bus 904, the bridge 905, and the external bus 906 do not necessarily need to be configured separately, and these functions may be implemented in one bus.

The input device 908 includes input sections such as a mouse, a keyboard, a touch panel, a button, a microphone, a switch, and a lever that a user uses to input information, an input control circuit that generates an input signal based on the input from the user and outputs the input signal to the CPU 901, and the like. The user who operates the information processing device 900 can input various items of data to the information processing device 900 and instruct a processing operation by operating this input device 908.

The output device 909 includes, for example, a display device such as a Cathode Ray Tube (CRT) display device, a Liquid Crystal Display (LCD) device, an Organic Light Emitting Diode (OLED) device, or a lamp, an audio output device such as a speaker, and the like.

The storage device 910 is a device for data storage. The storage device 910 may include a storage medium, a recording device that records data in the storage medium, a read-out device that reads out data from the storage medium, a deletion device that deletes the data recorded in the storage medium, and the like. The storage device 910 is configured as, for example, a Hard Disk Drive (HDD). This storage device 910 drives the hard disk, and stores the programs to be executed by the CPU 901 and the various items of data.

The communication device 911 is, for example, a communication interface that is configured as a communication device or the like for connecting to the network. Furthermore, the communication device 911 may support any one of wireless communication and wired communication.

The hardware configuration example of the information processing device 900 that is the example of the server 10 according to the embodiment of the present invention has been described.

### 3. Modified Example

Although the preferred embodiment of the present invention has been described in detail above with reference to the accompanying drawings, the present invention is not limited to this embodiment. It is obvious that one who has ordinary knowledge in the field of the technique to which the present invention belongs can arrive at various change examples or alteration examples within a scope of the technical idea recited in the claims, and it is understood that these change examples and alteration examples also naturally belong to the technical scope of the present invention.

### 3-1. Modified Example Related to Thinning Decision Section

The example has been described above where the thinning decision section 130 determines whether or not to thin the message data belonging to the type “intrinsic reward” based on whether or not the number of times after the action of the random number on the cumulative number of times of behavior is a value of the cumulative behavior count parameter N or more. However, the thinning decision section 130 may not make the random number act on the cumulative number of times of behavior.

That is, the thinning decision section 130 may determine whether or not to thin the message data belonging to the type “intrinsic reward” based on whether or not the cumulative number of times of behavior is the value of the cumulative behavior count parameter N or more.

Furthermore, the case has been mainly described above where the thinning decision section 130 uses the cumulative number of times of behavior that is the number of times of execution of staircase walking by the user after the final reward time to determine whether or not to thin the message data belonging to the type “intrinsic reward”. However, the thinning decision section 130 uses an elapsed time from the final reward time to the current time to determine whether or not to thin the message data belonging to the type “intrinsic reward”.

That is, the thinning decision section 130 may calculate the elapsed time to the current time from the final reward time at which the message data belonging to the type “intrinsic reward” has been provided to the user terminal 20. Furthermore, when the type candidate data includes the type “intrinsic reward”, the thinning decision section 130 may determine whether or not to thin the message data belonging to the type “intrinsic reward” based on the progress data and the elapsed time.

More specifically, when the type candidate data includes the type “intrinsic reward”, the thinning decision section 130 may acquire a second value (hereinafter, also referred to as a “time lapse parameter T”) associated with the progress data. Furthermore, the thinning decision section 130 may make a random number act on the elapsed time calculated as described above.

Here, a case will be mainly assumed where action of the random number on the elapsed time is addition of the random number to the elapsed time. In this case, the random number may be, for example, a random integer number belonging to a range from −m to +m (in this regard, m represents a positive number). However, the action of the random number on the elapsed time may be multiplication of the random number on the elapsed time, or may be other arithmetic operations of the random number.

Furthermore, the thinning decision section 130 may determine whether or not to thin the message data belonging to the type “intrinsic reward” based on whether or not a time after the action of the random number is a value of the time lapse parameter T or more. In this case, as described with reference to the above concepts (a1) and (a2), the time lapse parameter T is desirably larger as the progress data associated with the time lapse parameter T is higher.

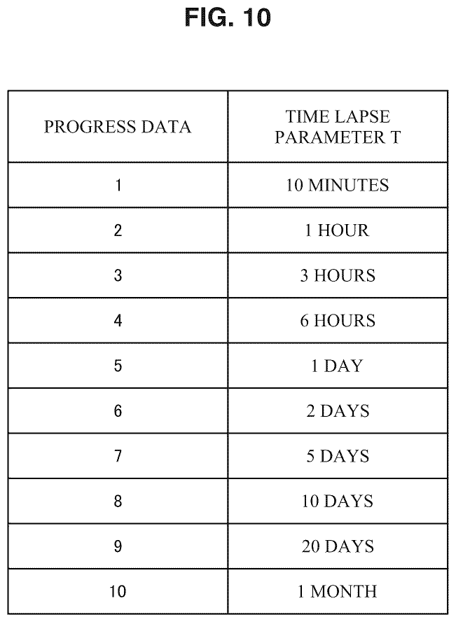

FIG. 10 is a view illustrating an example of a correspondence between progress data and the time lapse parameter T. As illustrated in FIG. 10, the correspondence between the progress data and the time lapse parameter T is held in advance by the thinning decision section 130. It is also grasped in the example illustrated in FIG. 10 that the time lapse parameter T is larger as the progress data associated with the time lapse parameter T is higher.

Note that the thinning decision section 130 may not make the random number act on the elapsed time from the final reward time to the current time similarly to a case where the cumulative number of times of behavior is used. That is, the thinning decision section 130 may determine whether or not to thin the message data belonging to the type “intrinsic reward” based on whether or not the elapsed time from the final reward time to the current time is the value of the time lapse parameter T or more.

### 3-2. Modified Example Related to Correction of Selection Probability

The case has been described above where, when there is a type for which a value “1: (to thin)” indicating to thin message data is output as the thinning decision data, the intervention control section 120 corrects the selection probability associated with this type to zero. In this case, a selection probability associated with a type (hereinafter, also referred to as “another type”) other than the type for which “1: (to thin)” has been output may not be corrected or may be corrected.

In one example, the intervention control section 120 may correct the selection probability associated with the another type by allocating a per-correction selection probability associated with the type for which “1: (to thin)” has been output to a selection probability associated with the another type.

### 3-3. Modified Example Related to Average Number of Times of Selection Per Day

The case has been mainly described above where the correspondence (FIG. 8) between the progress data and the average number of times of selection per day is held in advance per type to which message data belongs. However, the correspondence between the progress data and the average number of times of selection per day may be held per combination of a plurality of items of thinning decision data.

That is, the correspondence between the progress data and the average number of times of selection per day may be held per combination (2×2=4 types) of whether or not to thin message data belonging to the type “intrinsic reward” (two types), and whether or not to thin message data belonging to the type “extrinsic reward” (two types).

### 3-4 Modified Example Related to Target Behavior

Although the case has been described above where the user habituates staircase walking that is an example of a target behavior, the target behavior is not limited to staircase walking.

For example, the target behavior may be walking, eating, exercise, an interaction, learning, or an environmentally friendly behavior. In this case, by defining a type of terminal response data according to a type of the target behavior, it is possible to provide a similar effect to an effect provided when the target behavior is staircase walking. When, for example, the target behavior is the environmentally friendly behavior, a greenhouse gas amount of a purchased product may be defined as terminal response data.

### 3-5. Modified Example Related to System Configuration

The case has been mainly described above where the intervention condition decision section 110, the intervention control section 120, the thinning decision section 130, and the intervention section 140 are included in the server 10, and the user terminal 20 is a portable terminal. However, the configuration of the behavior change intervention system 1 is not limited to this example.

For example, all or part of the intervention condition decision section 110, the intervention control section 120, the thinning decision section 130, and the intervention section 140 may be included in the user terminal 20, and the user terminal 20 may be a signage terminal, a smart speaker, or a communication robot. Furthermore, all items of the terminal response data input to the intervention condition decision section 110 do not need to be acquired from the user terminal 20. For example, a camera system installed in a building may photograph a user, and output to the intervention condition decision section 110 behavior data of the user recognized from images shot by the camera system.

What is claimed is:

1. A behavior change intervention system comprising:
a decision section configured to obtain progress data by deciding a progress of behavior change related to a target behavior of a target;
a determination section configured to determine a selection probability of each type for selecting intervention information for the target, based on the progress data; and
a provision section configured to provide to the target with the intervention information for the target based on the selection probability.

2. The behavior change intervention system according to claim 1, wherein the determination section acquires an average number of times of selection during a predetermined time associated with each of one or a plurality of types to which an intervention information group belongs, and the progress data, determines based on the average number of times of selection and an output probability of the intervention information for the target the selection probability that is a probability of each type for selecting intervention information belonging to the type as the intervention information for the target.

3. The behavior change intervention system according to claim 2, wherein
the intervention information group includes a first type to which intervention information for recommending execution of the target behavior belongs, and
the average number of times of selection associated with the first type is larger as the progress data is higher in a section in which the progress data is smaller than predetermined first progress data, and is smaller as the progress data is higher in a section in which the progress data is higher than the first progress data.

4. The behavior change intervention system according to claim 2, wherein
the intervention information group includes a second type to which intervention information indicating an intrinsic reward given to execution of the target behavior belongs, and
the average number of times of selection associated with the second type is larger as the progress data is higher.

5. The behavior change intervention system according to claim 2, wherein
the intervention information group includes a third type to which intervention information indicating an extrinsic reward given to execution of the target behavior belongs, and
the average number of times of selection associated with the third type is smaller as the progress data is higher.

6. The behavior change intervention system according to claim 2, wherein
the intervention information group includes a fourth type to which intervention information indicating an effect obtained by execution of the target behavior belongs, and
the average number of times of selection associated with the fourth type is smaller as the progress data is higher.

7. The behavior change intervention system according to claim 2, wherein the determination section acquires an output probability of the intervention information for the target associated with a time zone to which a current time belongs as a current time message output probability, and determines the selection probability based on multiplication of the current time message output probability and the average number of times of selection.

8. The behavior change intervention system according to claim 1, wherein, when type candidate data including one or a plurality of types to which an intervention information group belongs includes a predetermined type to which intervention information related to a reward given to execution of the target behavior belongs, the determination section determines whether or not to use the intervention information included in the intervention information group and belonging to the predetermined type as a candidate of the intervention information for the target as the information related to the provision.

9. The behavior change intervention system according to claim 8, wherein, when the type candidate data includes the predetermined type, the determination section determines whether or not to use the intervention information included in the intervention information group and belonging to the predetermined type as the candidate of the intervention information for the target based on the progress data and a cumulative number of times of a behavior that is a number of times of execution of the target behavior by the target after the intervention information belonging to the predetermined type is lastly provided to the target.

10. The behavior change intervention system according to claim 9, wherein, when the type candidate data includes the predetermined type, the determination section acquires a first value associated with the progress data, and determines whether or not to use the intervention information included in the intervention information group and belonging to the predetermined type as the candidate of the intervention information for the target based on whether or not a number of times after action of a random number on the cumulative number of times of behavior or the cumulative number of times of behavior is the first value or more.

11. The behavior change intervention system according to claim 10, wherein the first value is larger as the progress data associated with the first value is higher.

12. The behavior change intervention system according to claim 8, wherein, when the type candidate data includes the predetermined type, the determination section determines whether or not to use the intervention information included in the intervention information group and belonging to the predetermined type as the candidate of the intervention information for the target based on the progress data and an elapsed time to a current time from a last time when the intervention information belonging to the predetermined type is provided to the target.

13. The behavior change intervention system according to claim 12, wherein, when the type candidate data includes the predetermined type, the determination section acquires a second value associated with the progress data, and determines whether or not to use the intervention information included in the intervention information group and belonging to the predetermined type as the candidate of the intervention information for the target based on whether or not a time after action of a random number on the elapsed time or the elapsed time is the second value or more.

14. The behavior change intervention system according to claim 13, wherein the second value is larger as the progress data associated with the second value is higher.

15. The behavior change intervention system according to claim 8, wherein the determination section
acquires an average number of times of selection during a predetermined time associated with each of the one or the plurality of types to which the intervention information group belongs, and the progress data, and determines based on the average number of times of selection a selection probability that is a probability of each type for selecting intervention information belonging to the type as the intervention information for the target, and
corrects the selection probability associated with the predetermined type to zero when the intervention information included in the intervention information group and belonging to the predetermined type is not used a candidate of the intervention information for the target.

16. The behavior change intervention system according to claim 2, wherein
the decision section specifies the intervention information group associated with a situation of the target, and
the provision section determines the intervention information for the target from the intervention information group.

17. The behavior change intervention system according to claim 1, wherein the intervention information for the target includes message data for encouraging the target to execute the target behavior.

18. The behavior change intervention system according to claim 1, wherein the decision section decides the progress based on at least one of an access frequency of the target to a service function, a number of days of execution of the target behavior by the target, and an acceptance degree of the target for intervention information provided to the target.

19. A behavior change intervention method comprising:
obtaining progress data by deciding a progress of behavior change related to a target behavior of a target;
determining a selection probability of each type for selecting intervention information to the target, based on the progress data; and
providing to the target with the intervention information for the target based on the selection probability.

20. A non-transitory computer readable storage medium having recorded therein a program that causes a computer to function as:
a decision section configured to obtain progress data by deciding a progress of behavior change related to a target behavior of a target;
a determination section configured to determine a selection probability of each type for selecting intervention information for the target based on the progress data; and
a provision section configured to provide to the target with the intervention information for the target based on the selection probability.
